(19) United States
(12) Patent Application Publication
(10) Pub. No.: US 2019/0048956 A1
(43) Pub. Date: Feb. 14, 2019

(54) VIBRATION DAMPING DEVICE

(71) Applicant: SUMITOMO RIKO COMPANY LIMITED, Komaki-shi (JP)

(72) Inventors: Hiroyuki KASHIHARA, Komaki-shi (JP); Hirotaka MATSUI, Novi, MI (US); Mutsumi MURAOKA, Novi, MI (US)

(73) Assignee: SUMITOMO RIKO COMPANY LIMITED, Komaki-shi (JP)

(21) Appl. No.: 15/671,731

(22) Filed: Aug. 8, 2017

(51) Int. Cl. F16F 1/371

(52) U.S. Cl. CPC F16F 1/371; F16F 1/44

(57) ABSTRACT

An outer member fixed to an outer peripheral portion of a main rubber elastic body has a projecting part projecting peripherally outward. First and second assembly members each include an annular fastening plate part so that the annular fastening plate parts are superposed and fixed while clamping the projecting part to constitute a bracket supporting the projecting part. A clinch fastening part is formed such that one of the annular fastening plate parts is folded back to cover an outer peripheral rim of the other annular fastening plate part and fastened by clinching to the other annular fastening plate part with clinching force being not directly exerted on the projecting part. A locking section is provided at the annular fastening plate part of at least one of the assembly members, and the projecting part being locked and positioned relative to the annular fastening plate part.

### TECHNICAL FIELD

This invention relates to a vibration damping device applied to an automotive engine mount etc., especially to a vibration damping device including a bracket.

### BACKGROUND ART

Conventionally, there has been known a vibration damping device using the vibration attenuating capability of a rubber elastic body, as a kind of vibration damping linkage body or vibration damping support body disposed between components of a vibration transmission system to link them to each other in a vibration-damping manner. The vibration damping device is used for an automotive engine mount, a body mount, a differential mount, or the like.

As Japanese Unexamined Patent Publication No. JP-A-2006-083980 (Patent Document 1) or the like discloses, this vibration damping device generally has a structure wherein an inner member is fixed to a central portion of a main rubber elastic body, while an outer member is fixed to an outer peripheral portion of the main rubber elastic body.

The inner member is attached to a power unit or the like, while the outer member is attached to a vehicle body or the like, whereby the vibration damping device is mounted between the components of the vibration transmission system.

For the outer member fixed to an outer peripheral surface of the main rubber elastic body, there is a case where it is difficult to directly provide the outer member with an attachment part that should be attached to the vehicle body etc., for reasons relating to molding of the main rubber elastic body, assembly step of another member, and the like. In light of this, there was proposed a structure wherein a separate bracket is fixed later to the outer member, and the outer member is attached to the vehicle body etc. via this bracket, as also disclosed in Patent Document 1 mentioned above, for example. As the fixation structure for fixing the bracket to the outer member, clinch fastening, i.e., fastening the outer member to the bracket by performing clinching process on the outer member is preferably adopted because clinch fastening can stably provide excellent fixation strength, and for other reasons.

However, the fixation structure for the bracket by the clinching process of the outer member in the vibration damping device having the conventional structure, as disclosed in Patent Document 1, sometimes may limit the degree of freedom in design. Thus, it would be difficult to realize the required material, strength, and performance in some cases. Specifically, it might be difficult to use a synthetic resin, an aluminum alloy, or the like, which is lighter than iron, for example, for the outer member that should be subjected to the clinching process, while securing the fixation strength for the outer member and the bracket.

### BACKGROUND ART DOCUMENT(S)

### Patent Document(s)

Patent Document 1: JP-A-2006-083980

### SUMMARY OF THE INVENTION

### Problems the Invention Attempts to Solve

The present invention was established in view of the above background, and one object of the present invention is to provide a vibration damping device of novel structure wherein a bracket is fixed later to an outer member.

### Means for Solving the Problem

A first mode of the present invention provides a vibration damping device comprising: a main rubber elastic body; an inner member being fixed to a central portion of the main rubber elastic body; an outer member being fixed to an outer peripheral portion of the main rubber elastic body while having a projecting part projecting peripherally outward; a bracket supporting the projecting part in the outer member; a first assembly member and a second assembly member each including an annular fastening plate part so that the annular fastening plate part of the first assembly member and the annular fastening plate part of the second assembly member are superposed and fixed to each other with the projecting part between them so as to constitute the bracket; a clinch fastening part being formed such that the annular fastening plate part of one of the first assembly member and the second assembly member is folded back to cover an outer peripheral rim of the annular fastening plate part of an other one of the first assembly member and the second assembly member, and is fastened by clinching to the annular fastening plate part of the other one with a clinching force being not directly exerted on the projecting part; and a locking section by which the projecting part of the outer member is locked and positioned relative to the annular fastening plate part of at least one of the first assembly member and the second assembly member.

According to the vibration damping device structured following the present mode, the outer member is positioned relative to and supported by the bracket by clinching the bracket, not by clinching the outer member like in the vibration damping device disclosed in Patent Document 1. This makes it possible to obtain a great degree of freedom in designing the material, the strength, and the like of the outer member.

The clinching force exerted on both fastening plate parts of the first and second assembly members by the clinch fastening part is not directly exerted on the projecting part. This avoids a great clinching force from acting on the outer member. Besides, the outer member and the bracket can be positioned relative to each other by the locking section. This makes it possible to keep the clinching force of the first and second assembly members constituting the bracket, while avoiding damages and the like by excessive external force acting on the outer member. Additionally, it becomes possible to ensure the strength of positioning between the bracket and the outer member.

A second mode of this invention provides the vibration damping device according to the first mode, further comprising a buffer rubber provided between the projecting part of the outer member and at least one of the first assembly member and the second assembly member clamping the projecting part.

According to the vibration damping device constructed following the present mode, the clamping force exerted on the projecting part of the outer member by the first and second assembly members acts in cushioned fashion by elastic deformation of the buffer rubber. This can alleviate the external force exerted on the projecting part during the clinching process, for example, as well as the change of the clamping force on the projecting part that may occur due to possible errors in the dimensions of the parts and the clinching process.

A third mode of this invention provides the vibration damping device according to the first or second mode, wherein the outer member is made of synthetic resin or light metal.

According to the vibration damping device having the structure following the present mode, weight reduction can be performed for the outer member, and hence the vibration damping device. Especially by making the outer member of synthetic resin, it is possible to further improve the degree of freedom in designing the shape, the material, and the like of the outer member, compared with an outer member made of metal, for example. In addition, it is also possible to prevent electric corrosion of the outer member in the contact section thereof with the bracket made of metal.

A fourth mode of this invention provides the vibration damping device according to any one of the first to third modes, wherein the outer member includes a plurality of outer segments disposed separately in a peripheral direction of the main rubber elastic body.

According to the vibration damping device structured following the present mode, the deformation restraint force on the main rubber elastic body due to the outer member can be decreased as well. For example, by setting as appropriate the deformation restraint force by the outer segments bonded on the main rubber elastic body in the peripheral direction, it becomes possible to tune the spring characteristics of the vibration damping device. Specifically, it is also possible to largely set the spring ratio between two axis-perpendicular directions orthogonal to each other, by mutually opposing a pair of outer segments in the axis-perpendicular direction of the main rubber elastic body, for example.

A fifth mode of this invention provides the vibration damping device according to any one of the first to fourth modes, wherein the outer member has a peripheral wall covering an outer peripheral surface of the main rubber elastic body, while the bracket is disposed peripherally outside the peripheral wall, and a cover rubber is provided on an outer peripheral face of the peripheral wall.

With the vibration damping device constructed according to the present mode, even if the outer periphery of the outer member is held by the bracket in contact therewith, for example, the cover rubber can be interposed between both contact faces, thereby enabling avoidance of direct contact between the outer member and the bracket. Therefore, it is also possible to reduce excessive contact force of the bracket on the outer member, and abrasion due to interference with the bracket accompanying the deformation and the displacement of the outer member when the external force acts, for example.

The buffer rubber in the second triode and the cover rubber in this mode may be formed integrally with the main rubber elastic body.

A sixth mode of this invention provides the vibration damping device according to any one of the first to fifth modes, wherein the locking section is constituted by a locking structure having a concave portion provided at one of the annular fastening plate part and the projecting part and a convex portion provided at an other one of the annular fastening plate part and the projecting part.

According to the vibration damping device having the structure following the present mode, the detaining structure between the outer member and the bracket can be realized by a concave and convex detaining structure. Particularly, the concave portion and the convex portion preferably have a detaining structure wherein the portions open or protrude in the superposition direction of the both fastening plate parts in the first and second assembly members constituting the bracket, so as to be engaged in one another. This facilitates the assembly manipulation for the outer member and the bracket, as well as securement of the positioning force in the axis-perpendicular direction of the main rubber elastic body.

A seventh mode of this invention provides the vibration damping device according to any one of the first to sixth modes, wherein the first assembly member is constituted by a bottom side member provided at one end side of the main rubber elastic body, while the second assembly member is constituted by a tubular member disposed on an outer peripheral surface of the main rubber elastic body, and the annular fastening plate parts superposed to each other with the projecting part of the outer member between them are provided at an outer peripheral edge of the bottom side member and an opening peripheral end on an axial side of the tubular member.

With the vibration damping device structured according to this mode, the bottom side member and the tubular member serving as the first and second assembly members constituting the bracket may be fastened by clinching to one another across about the entire periphery in the peripheral direction.

### Effect of the Invention

In the vibration damping device constructed according to the present invention, the detaining section positioning the projecting part of the outer member relative to the bracket is provided. Also, the mutual direct clinching force in the first and second assembly members constituting the bracket is not directly exerted on this projecting part. This makes it possible to secure both the clinching force of the first and second assembly members and the positioning force of the outer member relative to the bracket. Meanwhile, it is also possible to prevent the clinching force of the bracket from acting directly on the outer member.

### BRIEF DESCRIPTION OF THE DRAWINGS

FIG. 1 is a perspective view of a vibration damping device as a first embodiment of the present invention.

FIG. 2 is a front view of the vibration damping device shown in FIG. 1.

FIG. 3 is a right side view of the vibration damping device shown in FIG. 1.

FIG. 4 is a cross-sectional view taken along line 4-4 of FIG. 2.

FIG. 5 is a cross-sectional view taken along line 5-5 of FIG. 2.

FIG. 6 is a cross-sectional view taken along line 6-6 of FIG. 3.

FIG. 7 is an enlarged perspective view of a pair of outer segments that constitute the vibration damping device shown in FIG. 1.

FIGS. 8A and 8B are respectively a front view and a bottom plan view of the outer segment shown in FIG. 7.

FIG. 9 is a perspective view of the vibration damping device shown in FIG. 1 with a second assembly member omitted.

FIG. 10 is a vertical cross sectional view of the vibration damping device shown in FIG. 9, corresponding to FIG. 4.

FIG. 11 is a vertical cross sectional view of a vibration damping device as a second embodiment of the present invention, corresponding to FIG. 4.

FIGS. 12A and 12B are respectively a perspective view and a bottom plan view of an outer member that constitutes the vibration damping device shown in FIG. 11.

### EMBODIMENTS FOR CARRYING OUT THE INVENTION

In order to clarify the present invention more specifically, embodiments of the present invention will be described in detail below in reference to the drawings.

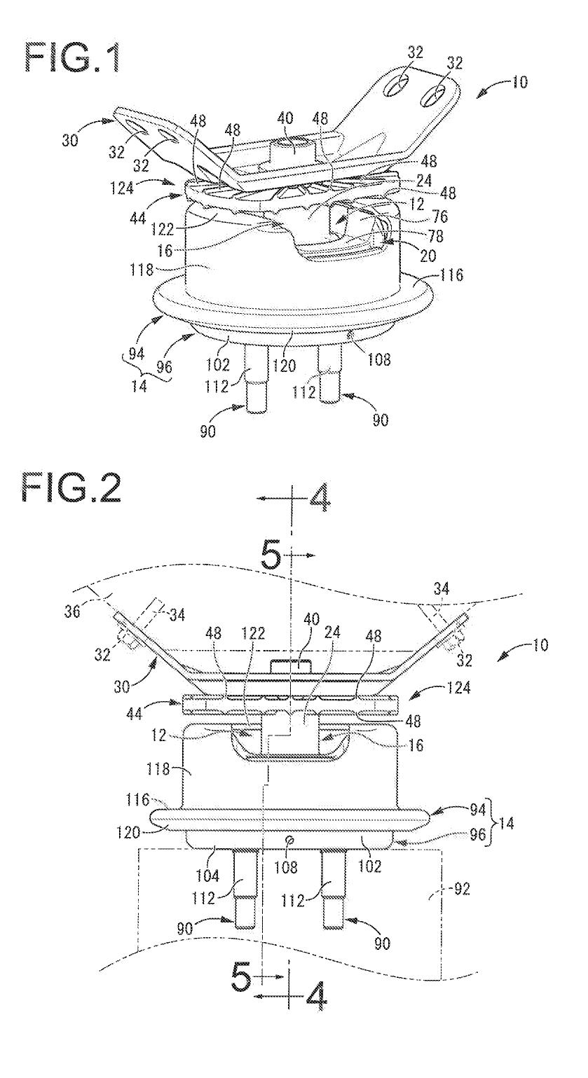

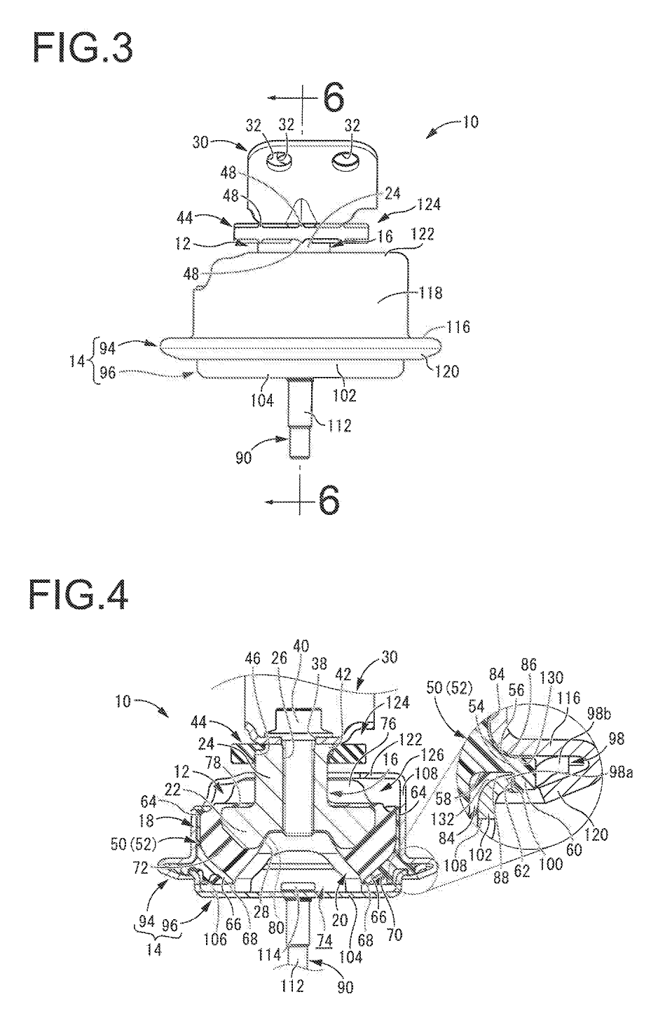

FIGS. 1 to 6 show an automotive engine mount 10 serving as a first embodiment of the vibration damping device according to the present invention. The engine mount 10 includes a mount main unit 12 serving as a vibration damping device main unit, and an outer bracket 14 serving as a bracket that is mounted onto the mount main unit 12. The mount main unit 12 has a structure in which an inner member 16 and an outer member 18 are elastically linked by a main rubber elastic body 20. In the description hereinbelow, the up-down direction means the up-down direction in FIG. 2, which is the mount axial direction (the axial direction of the main rubber elastic body 20) that coincides with the elastic principal axis in which the main support load is input. Besides, the left-right direction means the left-right direction in FIG. 2. Also, the front-back direction means the left-right direction in FIG. 3, which is the vehicle front-back direction with the engine mount 10 mounted onto the vehicle.

Described more specifically, the inner member 16 is a rigid component made of metal, synthetic resin or the like, and includes a bonded part 22 having a thick, generally circular disk shape overall. The inner member 16 of the present embodiment integrally includes a fastening part 24 that projects upward from the roughly center of the bonded part 22. A screw hole 26 perforates the bonded part 22 and the fastening part 24 on their roughly center axes in the up-down direction.

The bonded part 22 spreads over the entire periphery of the screw hole 26 with a generally constant cross-sectional shape, and has the outer peripheral surface that extends in the axial direction and the top face that is roughly flat. The bottom face of the bonded part 22 has a roughly mountain cross section that projects downward. With this configuration, the bonded part 22 of the present embodiment has a generally annular block shape that extends in the peripheral direction around the screw hole 26. In addition, the bottom face of the bonded part 22, which has the mountain cross section, has the tapered outer peripheral surface whose outside diameter dimension gradually becomes smaller downward, and the tapered inner peripheral surface whose inside diameter dimension gradually becomes larger downward. The bonded part 22 further includes a recess 28 having a roughly inverted conical shape that opens downward in the center of the bottom face thereof.

Moreover, on the upper end of the inner member 16, an inner bracket 30 is attached. The inner bracket 30 includes attachment bolt holes 32. By attachment bolts 34 (see FIG. 2) being inserted into the attachment bolt holes 32 and threaded onto a power unit 36, the inner member 16 is configured to be fixed to the power unit 36 via the inner bracket 30.

The inner bracket 30 of the present embodiment has a roughly rectangular plate shape that spreads out in the axis-perpendicular direction and extends in the left-right direction overall. The lengthwise (left-right) medial portion of the inner bracket 30 spreads out in a generally flat shape, while the lengthwise both end portions extend diagonally upward so as to slope outward in the left-right direction. In each of the sloping both end portions, a plurality of the attachment bolt holes 32, 32 are formed.

The central portion of the inner bracket 30 is perforated by a through hole 38 in the thickness direction (up-down direction). A connection bolt 40 is inserted into the through hole 38 and threaded onto the screw hole 26 of the inner member 16, so that the inner bracket 30 is overlapped on the top face of the fastening part 24 and fixed thereto by fastening.

On the outer peripheral surface of the upper end portion of the fastening part 24, there is formed a fitting part 42 having a concave and convex shape, and a cushion member 44 is mated and supported with respect to the fitting part 42.

The cushion member 44 is a component made of rubber, elastomer or the like with elasticity, and has a roughly plate shape that spreads out in the mount axis-perpendicular direction. In the state of being externally fitted onto the bonded part 22 of the inner member 16, the cushion member 44 is mounted along the bottom face of the inner bracket 30. In the present embodiment, in plan view, the cushion member 44 has a generally elliptical shape having such a size that the bottom face of the medial portion of the inner bracket 30, which has a roughly flat shape, can be covered over its entirety. A fitting hole 46 that perforates the central portion of the cushion member 44 is placed externally onto the fitting part 42 of the fastening part 24, and the inner peripheral edge of the fitting hole 46 is clamped between the fastening part 24 and the inner bracket 30, so that the cushion member 44 is positioned and retained. Besides, in the present embodiment, on both top and bottom faces of the cushion member 44, there are integrally formed a plurality of linear ridges 48 projecting therefrom and extending in the radial direction, thereby improving cushioning action described later.

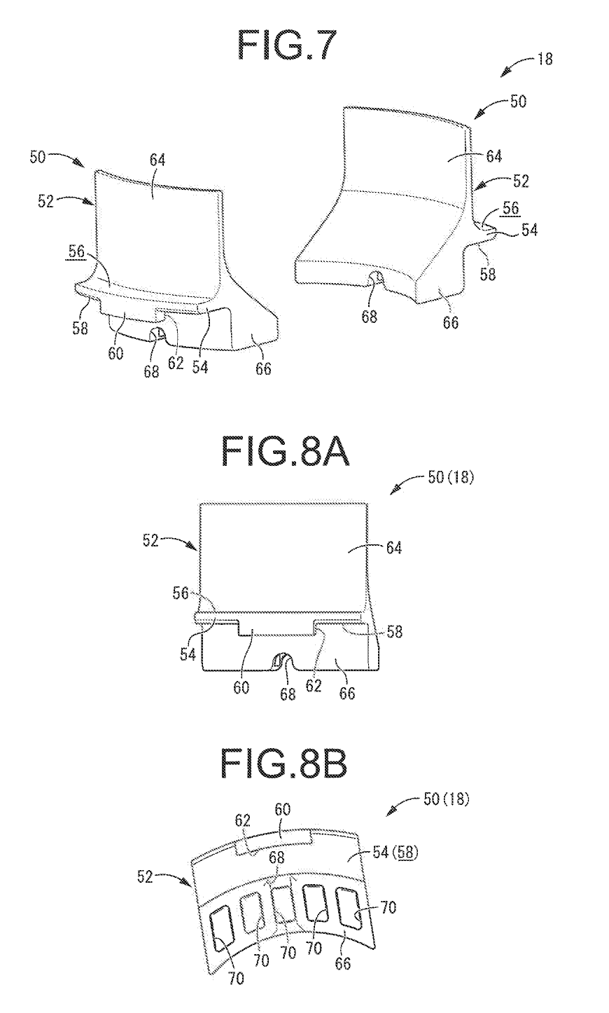

Moreover, as shown in FIG. 7, the outer member 18 of the present embodiment includes a pair of outer segments 50, 50. Since the pair of outer segments 50, 50 are approximately identical in shape with each other, in the following description, one outer segment 50 will be described. Whereas the outer member 18 (the outer segments 50, 50) may be made of metal such as iron, it is preferable for the outer member 18 to be made of light metal such as light alloy including aluminum alloy or the like that has smaller specific gravity than iron, or be made of synthetic resin. In the present embodiment, the outer member 18 is made of synthetic resin.

Specifically, as shown in FIGS. 7, 8A and 8B, the outer segment 50 has a peripheral wall 52 of roughly curved, arcuate plate shape having a prescribed peripheral dimension, and on the outer peripheral face of the outer segment 50 (the peripheral wall 52), a projecting part 54 is integrally formed so as to project radially outward. In the present embodiment, the projecting part 54 includes a top face 56 and a bottom face 58 that spread roughly horizontally (namely roughly in the axis-perpendicular direction), so that the projecting part 54 has a generally plate shape extending on the outer peripheral face of the outer segment 50 (the peripheral wall 52) across the approximately entire length in the peripheral direction. With this configuration, each of the top face 56 and the bottom face 58 of the projecting part 54 is a flat surface of arcuate shape having a prescribed width that curves in the peripheral direction with a generally constant projecting dimension along the outer peripheral face of the outer segment 50. In this embodiment in particular, the top and bottom of the projecting part 54 are made different in their outside diameter dimensions, namely, the inner peripheral end of the top face 56 is positioned radially outside of the inner peripheral end of the bottom face 58. Thus, in plan view, compared with the top face 56, the bottom face 58 is formed with its inner peripheral end made smaller in diameter and with a larger area.

On the bottom face 58 of the projecting part 54, there is formed an engagement convex portion 60 serving as a convex portion that projects downward. In the present embodiment, the peripheral dimension of the engagement convex portion 60 is made smaller than the peripheral dimension of the projecting part 54, such that the engagement convex portion 60 is provided to the medial portion in the peripheral direction of the outer peripheral end of the bottom face 58 of the projecting part 54. Also, the engagement convex portion 60 of the present embodiment is formed with the projecting dimension so as not to reach the lower end of the outer segment 50 (the peripheral wall 52). The engagement convex portion 60 has a generally rectangular cross section in the radial direction, and the radial width dimension thereof is made smaller than the radial width dimension of the bottom face 58 of the projecting part 54, so that the engagement convex portion 60 is positioned so as to be remote from the peripheral wall 52 to the projecting distal end side of the projecting part 54. With this arrangement, on the bottom face of the projecting part 54 and radially between the peripheral wall 52 and the engagement convex portion 60, there is formed a mating groove 62 that opens downward with a prescribed radial width dimension.

In the present embodiment, with respect to the inner peripheral surface of the peripheral wall 52 extending in the up-dowry direction, the upper portion extends roughly straightly in the up-down direction, whereas the lower portion is a tapered surface that gradually projects radially inward towards the bottom. Meanwhile, the above-described projecting part 54 is formed near the upper end of the lower portion whose inner peripheral surface is the tapered surface, and the outer peripheral face of the peripheral wall 52 extends roughly straightly in the up-down direction on both the upper and lower sides of the projecting part 54. Accordingly, with respect to the peripheral wall 52 of the outer segment 50, the upper portion of the projecting part 54 constitutes a cover wall part 64 whose thickness dimension (the left-right direction in FIG. 4) is generally constant, while the lower portion of the projecting part 54 constitutes a base part 66 whose thickness dimension gradually increases towards the bottom.

Furthermore, in the present embodiment, on the bottom face of the base part 66, there is formed a communication groove 68 extending in the peripherally central portion across the entire length in the radial direction (thickness direction of the peripheral wall 52) with a generally semicircular cross section that opens downward. Additionally, the base part 66 includes a plurality of lightening holes 70 (five in the present embodiment) that open downward (see FIG. 8B).

The pair of outer segments 50, 50 of the above-described structure are disposed separately from each other in the peripheral direction. In the present embodiment, the pair of outer segments 50, 50 are disposed respectively on the opposite sides in the front-back direction with the inner member 16 interposed therebetween so as to be opposed to each other in the axis-perpendicular direction. The inner member 16 is disposed so as to be remote from the outer segments 50, 50 (the outer member 18) in the radial direction as well as in the axial direction. The axially opposed faces of the inner member 16 and the outer segments 50, 50 that slope in the radial direction are elastically linked by the main rubber elastic body 20 to each other. That is, the main rubber elastic body 20 includes a front and back pair of linkage rubbers 72, 72 that link the inner member 16 and the outer segments 50, 50 positioned on the opposite sides in the front-back direction. Thus, the inner member 16 is fixed to the central portion of the main rubber elastic body 20, and the pair of outer segments 50, 50 are fixed to the outer peripheral portion of the main rubber elastic body 20.

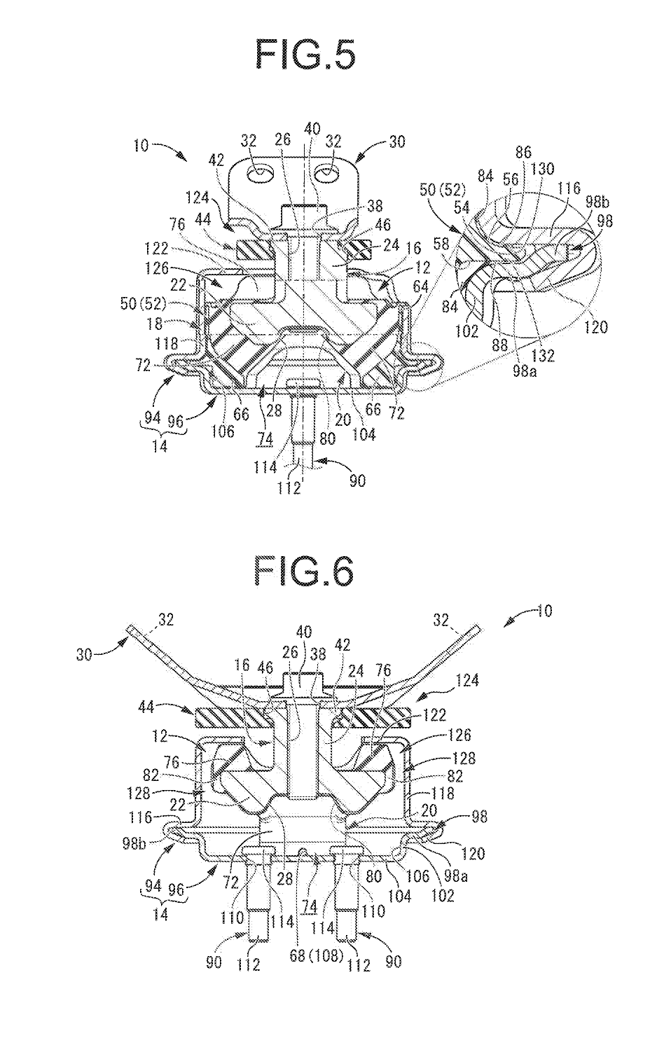

As shown in FIGS. 5 and 10, the linkage rubbers 72, 72 are disposed in the vehicle front-back direction so as to link the opposed faces of the tapered outer peripheral surface of the bonded part 22 of the inner member 16 and the tapered inner peripheral faces of the base parts 66, 66 of the outer segments 50, 50. With this arrangement, the linkage rubbers 72, 72 include linking portions that gradually spread towards the bottom while extending so as to slope in the axial direction from the inner member 16 toward the outer segments 50, 50. With respect to the linking portions, static compression force acts due to distributed load of the power unit, as well as occurrence of tensile stress is reduced during vibration input in the vehicle up-down direction or in the front-back direction in the mounted state. Thus, intended vibration damping performance will be exhibited with excellent durability.

Regarding the linking portions of the linkage rubbers 72, 72, which are disposed between the opposed faces of the inner member 16 and the outer segments 50, 50, the lower end face thereof is a sloping free surface, while the upper part thereof extends continuously so as to reach between the radially opposed faces of the outer peripheral surface of the inner member 16 and the peripheral walls 52, 52 of the outer segments 50, 50. Then, to the upper side of the inner peripheral faces of the linkage rubbers 72, 72, the outer peripheral surface of the inner member 16 is bonded, while to the upper side of the outer peripheral faces of the linkage rubbers 72, 72, the inner peripheral faces of the outer segments 50, 50 are bonded. Specifically, the outer peripheral faces of the linkage rubbers 72, 72 that constitute the main rubber elastic body 20 are covered by the peripheral walls 52, 52 of the outer segments 50, 50. In the present embodiment, the bonded part 22 of the inner member 16 and the upper ends of the outer segments 50, 50 are placed at the roughly same axial position, and the inner peripheral faces of the outer segments 50, 50 are bonded to the upper ends of the linkage rubbers 72, 72. Additionally, on the upper end faces of the linkage rubbers 72, 72, there are formed groove-shaped recesses extending along the outer segments 50, 50 in the peripheral direction, thereby enhancing the free surface and decreasing tensile stress.

Besides, the main rubber elastic body 20 of the present embodiment that includes the linkage rubbers 72, 72 takes the form of an integrally vulcanization molded component incorporating the inner member 16 and the outer segments 50, 50. That is, with respect to the integrally vulcanization molded component of the main rubber elastic body 20 of the present embodiment, when viewed in vertical cross section shown in FIG. 4, for which the front-back direction coincides with the left-right direction in the drawing, the lower side of the bonded part 22 of the inner member 16 has a roughly gate shape. Namely, leg parts (the linkage rubbers 72, 72 and the base parts 66, 66 of the outer segments 50, 50) are provided on the respective opposite sides in the front-back direction, and between the leg parts, there is provided a space 74 whose dimension in the front-back direction gradually becomes greater towards the bottom. Whereas the front and back linkage rubbers 72, 72 have a symmetrical shape in the present embodiment, the linkage rubbers 72, 72 may have different shapes from each other.

Moreover, on the top face of the bonded part 22 of the inner member 16, there are provided a pair of stopper rubbers 76, 76 projecting upward respectively on the opposite sides in the left-right direction with the inner member 16 interposed therebetween. In the present embodiment, the stopper rubbers 76, 76 have a tapered cross-sectional shape whose radial dimension progressively decreases towards the top.

Also, the bonded part 22 of the inner member 16 is covered by a rubber layer over the roughly entire face thereof The top face of the bonded part 22 is covered by an upper rubber sheath layer 78, while its bottom face is covered by a lower rubber sheath layer 80. Besides, to the outer peripheral surface of the bonded part 22, a pair of left and right stopper rubbers 82, 82 are bonded so as to project toward the opposite sides in the left-right direction.

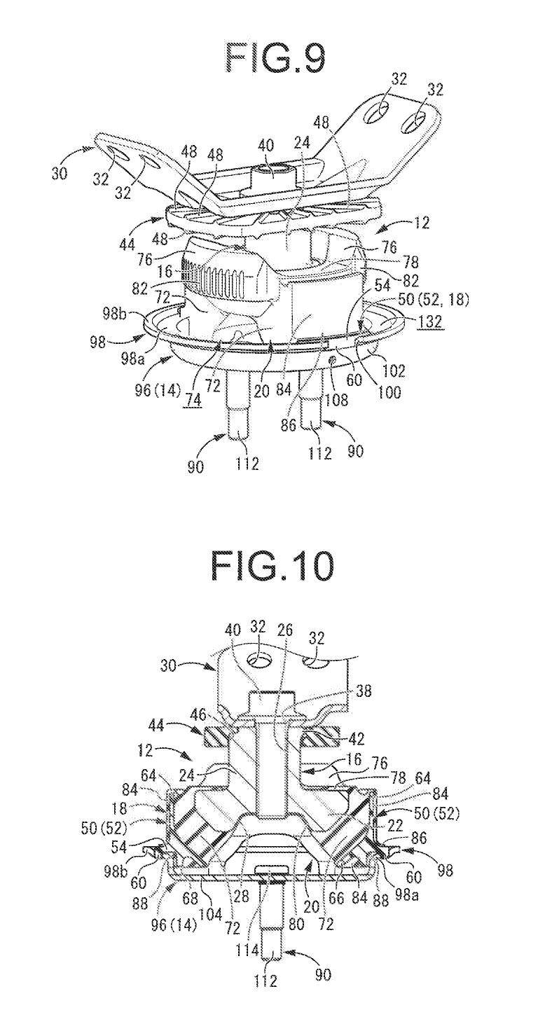

Furthermore, as shown in FIGS. 9 and 10, to each of the outer peripheral faces of the outer segments 50, 50, namely the outer peripheral faces of the peripheral walls 52, 52, a cover rubber 84 is bonded. Specifically, the cover rubbers 84, 84 having a prescribed thickness are bonded to the outer peripheral faces of the cover wall parts 64, 64 and to the area from the bottom faces of the base parts 66, 66 to the outer peripheral faces thereof. In addition, to the top faces 56, 56 of the projecting parts 54, 54, upper buffer rubbers 86, 86 serving as buffer rubbers are bonded with a prescribed thickness, while to the bottom faces 58, 58 of the projecting parts 54, 54, lower buffer rubbers 88, 88 serving as butler rubbers are bonded with a prescribed thickness.

In the present embodiment, the above-described linkage rubbers 72, 72, the stopper rubbers 76, 76, the upper rubber sheath layer 78, the lower rubber sheath layer 80, the left and right stopper rubbers 82, 82, the cover rubbers 84, 84, and the upper and lower buffer rubbers 86, 88 are integrally formed with the main rubber elastic body 20. That is, when viewed in vertical cross sections respectively shown in FIGS. 4 and 6 that are orthogonal to each other, the integrally vulcanization molded component of the main rubber elastic body 20 of the present embodiment has mutually different structures including presence or absence of the linkage rubbers 72, 72 and the outer segments 50, 50.

To the integrally vulcanization molded component of the main rubber elastic body 20 incorporating the inner member 16 and the outer member 18 (the outer segments 50, 50) having the aforementioned structure, the inner bracket 30 is attached as described above. Meanwhile, to the outer member 18 (the outer segments 50, 50), the outer bracket 14 is attached. The outer bracket 14 includes mounting bolts 90 formed projecting therefrom, and by the mounting bolts 90 being fixed to a vehicle body 92, the outer member 18 is configured to be fixed to the vehicle body 92 via the outer bracket 14.

The outer bracket 14 includes a first assembly member and a second assembly member that are dividable from each other. In the present embodiment, an upper bracket 94 serving as the second assembly member and a lower bracket 96 serving as the first assembly member are linked in the up-down direction by clinch fastening.

The lower bracket 96 of the present embodiment has a generally shallow, bottomed round cup shape overall. Also, the lower bracket 96 integrally includes a collar part 98 spreading in an outer flange shape from the outer peripheral edge of the lower bracket 96 that opens at the upper end of the tubular peripheral wall thereof (a side wall 102 described later). The collar part 98 constitutes a fastening plate part having a roughly annular disk shape. That is, to the outer peripheral edge of the lower bracket 96, the collar part 98 serving as the annular fastening plate part is provided.

In the present embodiment, at the radially medial portion of the collar part 98, there is provided a shoulder part that slopes and extends in the radial direction. Accordingly, provided are an inner peripheral collar portion 98a of an annular disk shape that is positioned on the radially inside of the shoulder part, and an outer peripheral collar portion 98b of an annular disk shape that is positioned on the radially outside of the shoulder part and is positioned above the inner peripheral collar portion 98a in the axial direction. The relative difference between the height positions of the inner peripheral collar portion 98a and the outer peripheral collar portion 98b, in other words, the height dimension of the shoulder part, is made greater than the thickness dimension of the projecting part 54 of the outer segment 50 but smaller than the total thickness dimension for which the thickness dimensions of the upper and lower buffer rubbers 86, 88, in the state before the assembly of the integrally vulcanization molded component of the main rubber elastic body 20 to the outer bracket 14, are added to the thickness dimension of the projecting part 54.

In the collar part 98, at prescribed locations on the circumference positioned on both sides of the front-back direction, engagement concave portions 100, 100 serving as concave portions are formed through it in the thickness direction (up-down direction) while opening to the outer circumference. The engagement concave portion 100 of this embodiment has a notch shape in the collar part 98. The circumferential dimension of each engagement concave portion 100 is equal to or slightly larger than the circumferential dimension of the engagement convex portion 60 provided at each outer segment 50. The engagement concave portion 100 is formed with the radial depth from the outer peripheral rim of the outer peripheral collar portion 98a across the shoulder part to the inner peripheral collar portion 98b.

By providing these engagement concave portions 100, 100, the outer diameter dimension of the collar part 98 is made smaller at the formation locations of the engagement concave portions 100, 100, namely the sections on the both sides of the front-back direction.

The side wall 102 of about cylindrical shape extends out downward from the inner peripheral rim of this collar part 98, while the lower opening of the side wall 102 is closed by a bottom wall 104 of about circular disk shape. The bottom wall 104 and the side wall 102 form a circular concavity 106 opening upward, at the central portion of the lower bracket 96. In the proximity of the lower end of the side wall 102 in the lower bracket 96, communication holes 108 are formed penetrating it in the thickness direction (radial direction), thus enabling drainage and the like.

In the bottom wall 104 of the lower bracket 96, bolt holes 110, 110 are formed at positions separated in the left-right direction. In the bolt holes 110, 110, the above-described mounting bolts 90, 90 are implanted. For the mounting bolt 90, a shaft portion 112 whereon a screw thread is formed protrudes downward from the lower bracket 96, while a head portion 114 is stored in the circular concavity 106.

Meanwhile, the upper bracket 94 of the present embodiment is constituted by a tubular member including a tubular wall part 118 of about annular plate shape, as a whole. In the lower opening peripheral end of the tubular wall part 118, which is the opening peripheral end on an axial side of the tubular wall part 118, a step part 116 is provided serving as an annular fastening plate part while expanding to the radial outside of the upper bracket 94.

A clinch fastening part 120 that fastens the lower bracket 96 by being subjected to the clinching process as described later is formed integrally with the outer peripheral rim of the step part 116. The clinch fastening part 120 is provided as continuous across the entire circumference in the circumferential direction of the upper bracket 94. In a state before the clinching process is performed, the clinch fastening part 120 may extend in the up-down direction, for example, or it may extend. from the outer peripheral rim of the step part 116 while spreading further to the radial outside. Specifically, for example, the upper bracket 94 can be formed with an initial configuration of about stepped tubular member, wherein the upper bracket 94 has the step part 116 in its axially middle part, and the tubular wall part in a small-diameter cylindrical form and the tubular wall part in a large-diameter cylindrical form extending respectively on the axially upper and lower sides of the step part 116. In the present embodiment, the outer diameter dimension of the tubular wall part 118 is made nearly equal to the maximum width dimension (left-right dimension) of the cushion member 44 provided at the upper end of the inner member 16.

With the opening peripheral end of the upper end of the tubular wall part 118, a stopper part 122 is integrally formed to protrude radially inward. Especially in this embodiment, the stopper part 122 is formed with an embodiment wherein it extends in the circumferential direction while spreading from the back part to the both left and right parts. In other words, the stopper part 122 is not formed in the front part of the upper end of the tubular wall part 118. When the upper bracket 94 is assembled to the mount main unit 12, this stopper part 122 is positioned outside the outer peripheral surface of the fastening part 24 of the inner member 16, separately from it. Then, the stopper part 122 is disposed between the axially opposed faces of the bonded part 22 of the inner member 16 and the inner bracket 30. Under this state, the stopper part 122 is abutted against the top face of the bonded part 22 of the inner member 16 via the stopper rubber 76, and against the bottom face of the inner bracket 30 via the cushion member 44.

In this embodiment, a bound stopper mechanism 124 is thus constituted by including the inner bracket 30, the stopper part 122, and the cushion member 44. The bound stopper mechanism 124 limits the axial deformation volume of the main rubber elastic body 20, and hence the displacement volume of the power unit relative to the vehicle body in the up-down direction, in cushioned fashion. Also, in the present embodiment, a rebound stopper mechanism 126 is constituted by including the bonded part 22, the stopper part 122, and the stopper rubber 76. The rebound stopper mechanism 126 limits the axial deformation volume of the main rubber elastic body 20, and hence the displacement volume of the power unit relative to the vehicle body in the up-down direction, in cushioned fashion.

Moreover, when the upper bracket 94 is assembled to the mount main unit 12, the tubular wall part 118 of the upper bracket 94 is positioned on the radial outside of the bonded part 22 of the inner member 16. Then, in the left-right direction of the vehicle, the outer peripheral surface of the bonded part 22 faces the tubular wall part 118 as separate with a prescribed radial distance. Thus, upon a large vibration load input in the left-right direction on the engine mount 10, the bonded part 22 of the inner member 16 is abutted against the tubular wall part 118 via the stopper rubber 82 on its surface. Specifically, in the present embodiment, axis-perpendicular direction stopper mechanisms 128, 128 are constituted by including the bonded part 22, the tubular wall part 118, and the left and right stopper rubbers 82, 82. The axis-perpendicular direction stopper mechanism 128 limits the deformation volume of the main rubber elastic body 20 in the axis-perpendicular direction, and hence the displacement volume of the power unit relative to the vehicle body in the left-right direction, in cushioned fashion.

To the outer bracket 14 (the upper bracket 94 and the lower bracket 96) having the above-described structure, the outer member 18 (the outer segments 50, 50) is assembled. That is, the integrally vulcanization molded component of the main rubber elastic body 20 incorporating the inner member 16 and the outer member 18 is inserted via the lower opening of the upper bracket 94. Also, the cushion member 44 and the inner bracket 30 are attached to the upper end portion of the inner member 16 protruding upward from the upper bracket 94 (the upper end portion of the fastening part 24). It is also possible to perform the diameter reduction process on the upper bracket 94 depending on the necessity; after inserting the integrally vulcanization molded component of the main rubber elastic body 20 in the upper bracket 94.

With the outer segments 50, 50 assembled to the upper bracket 94, the projecting parts 54, 54 are superposed on a lower face 130 of the step part 116. In the present embodiment, the top faces 56, 56 of the projecting parts 54, 54 are superposed and abutted to the lower face 130 of the step part 116 via the upper buffer rubbers 86, 86. Especially, in this embodiment, the cover wall parts 64, 64 in the outer segments 50, 50 extend out to the radial outside of the bonded part 22 in the inner member 16. Consequently, the upper bracket 94 is positioned peripherally outside the cover wall parts 64, 64 (the peripheral walls 52, 52 of the outer segments 50, 50).

Furthermore, it is desirable that the cover wall parts 64, 64 in the outer segments 50, 50 are superposed and abutted to the inner peripheral face of the upper bracket 94 via the cover rubbers 84, 84. By so doing, the upper bracket 94 is disposed on the outer peripheral faces of the cover rubbers 84, 84 in the main rubber elastic body 20. This structure enables the retaining strength of the outer segments 50, 50 by the outer bracket 14 to improve, while enabling the linkage rubbers 72, 72 to be subjected to pre-compression.

The lower bracket 96 is superposed and assembled to the integrally vulcanization molded component of the main rubber elastic body 20 from below. The step part 116 of the upper bracket 94 and the collar part 98 of the lower bracket 96 are superposed in the axial direction. Especially in the present embodiment, the outer peripheral collar portion 98b in the collar part 98 is superposed on the step part 116 in direct contact therewith.

In the state where the upper and lower brackets 94, 96 are assembled to the integrally vulcanization molded component of the main rubber elastic body 20 in this way, the clinch fastening by press working is performed. Specifically, in relation to the clinch fastening part 120 extending continuously from the step part 116 in the upper bracket 94, for example downward in a tubular shape, press working is performed as the clinch fastening part 120 is bent radially inward at the outer peripheral rim of the step part 116. Thus, the clinch fastening part 120 is folded back radially inward to cover the collar part 98 of the lower bracket 96 from the radial outside. The collar part 98, which is the outer peripheral edge of the lower bracket 96, is fastened by clinching, as the collar part 98 is clamped in contact from the both axial sides, by the clinch fastening part 120 that is the lower outer peripheral end of the upper bracket 94.

Specifically, the upper face (the inner face) of the clinch fastening part 120 folded back is abutted and superposed on the lower face(s) of the shoulder part provided for the radially middle portion in the lower bracket 96 and/or the outer peripheral collar portion 98b located on the radial outside of the shoulder part. In other words, the clinch fastening part 120 in the upper bracket 94 is formed with a dimension with which the clinch fastening part 120 does not reach the inner peripheral collar portion 98a when bent radially inward. In this way; the shoulder part and/or the outer peripheral collar portion 98b in the collar part 98 of the lower bracket 96 are/is clamped and supported in the up-down direction by the step part 116 and the clinch fastening part 120 in the upper bracket 94. This realizes direct clinch fastening of the upper and lower brackets 94, 96, which both are metallic members.

The part of the integrally vulcanization molded component of the main rubber elastic body 20 that is lower than the projecting parts 54 is housed as being fitted in the circular concavity 106 of the lower bracket 96. As a result, the side wall 102 of the lower bracket 96 is located peripherally outside the base parts 66, 66 in the outer segments 50, 50 (the peripheral walls 52, 52). The base parts 66, 66 may be abutted against the inner peripheral face of the side wall 102 via the cover rubbers 84. Specifically, in this embodiment, the lower bracket 96 is disposed on the lower end side, which is one end side, in the integrally vulcanization molded component of the main rubber elastic body 20. This lower bracket 96 constitutes the bottom side member covering the lower side part of the integrally vulcanization molded component of the main rubber elastic body 20.

In the present embodiment, the lower faces of the outer segments 50, 50 are superposed to the bottom wall 104 of the lower bracket 96 via the cover rubbers 84, 84 in contact therewith in the axial direction. These cover rubbers 84, 84 are compressed in the up-down direction by these outer segments 50, 50 and the bottom wall 104. This improves the strength of bearing and supporting by the lower bracket 96 in relation to the load of the outer segments 50, 50 to the axially lower side.

When the integrally vulcanization molded component of the main rubber elastic body 20 and the lower bracket 96 are assembled to one another, the communication grooves 68, 68 provided in the lower faces of the outer segments 50, 50 are continuous with the communication holes 108, 108 provided in the side wall 102 of the lower bracket 96 in the radial directions. Owing to this, drainage and air venting are attained through these communication grooves 68, 68 and communication holes 108, 108.

Here, when the integrally vulcanization molded component of the main rubber elastic body 20 and the lower bracket 96 are assembled to one another, the projecting parts 54, 54 of the outer segments 50, 50 are superposed to the inner peripheral collar portion 98a of the lower bracket 96. As the enlarged view of FIG. 5 shows, the outer peripheral edge of the projecting part 54 extends beyond the outer peripheral rim of the inner peripheral collar portion 98a to the inner periphery of the shoulder part. The bottom face of the outer peripheral edge of the projecting part 54 is formed to provide a tapered shape in a cross section, whereby the inner peripheral collar portion 98a is avoided from touching the shoulder part.

The engagement convex portions 60, 60 provided protruding at the projecting parts 54, 54 of the outer segments 50, 50 are inserted in the up-down direction and locked in the engagement concave portions 100, 100 provided at the collar part 98 of the lower bracket 96. Specifically, in this embodiment, the locking sections locking and positioning the projecting parts 54, 54 are constituted by the locking structure between the engagement convex portions 60, 60 provided at the projecting parts 54, 54 of the outer segments 50, 50 and the engagement concave portions 100, 100 provided at the collar part 98 of the lower bracket 96. In other words, both front and back side portions of the collar part 98 with a smaller projection dimension to the radial outside are inserted in the mating grooves 62, 62 opening downward in the outer segments 50, 50.

By the locking structure between the engagement convex portion 60 and the engagement concave portion 100, each outer segment 50 is positioned relative to the lower bracket 96 in the radial direction, and in this embodiment, positioned in the circumferential direction as well.

On the other hand, the projecting parts 54, 54 of the outer segments 50, 50 are clamped and fixed in the axial direction between the step part 116 of the upper bracket 94 and the collar part 98 of the lower bracket 96, in the clinch fastening section of the upper bracket 94 with respect to the collar part 98 of the lower bracket 96. In this fastening section, the projecting parts 54, 54 are clamped and supported in the up-down direction between the upper and lower brackets 94, 96 via the upper buffer rubbers 86, 86 and the lower buffer rubbers 88, 88. In short, the step part 116 of the upper bracket 94 and the collar part 98 (especially the inner peripheral collar portion 98a) of the lower bracket 96 are superposed to each other with the projecting parts 54, 54 between them. By performing the clinching process on the clinch fastening part 120, the step part 116 and the collar part 98 are fixed as they clamp the projecting parts 54, 54, thereby constituting the outer bracket 14.

Specifically, the upper butler rubber 86 is interposed between the opposed faces of the top face 56 of the projecting part 54 and the lower face 130 of the step part 116. On the other hand, the lower buffer rubber 88 is interposed between the opposed faces of the bottom face 58 of the projecting part 54 and an upper face 132 of the collar part 98. As a result, the clinch fastening sections of the upper and lower brackets 94, 96 are prevented from directly touching the projecting part 54, and the clinching force is reduced by the upper and lower buffer rubbers 86, 88, and thus avoided from acting directly on the projecting part 54. Although the clinching force on the projecting part 54 is reduced, the positioning force of the projecting part 54 relative to the clinch fastening section is kept by the aforesaid locking structure.

The clinching force by the clinch fastening part 120 of the upper bracket 94 is made to act directly between the step part 116, the outer peripheral collar portion 98b, and the clinch fastening part 120, which are superposed to one another in contact therewith. This can realize strong clinching force for the upper and lower brackets 94, 96. Meanwhile, the projecting part 54 having a smaller thickness dimension than the distance between the opposed faces of the step part 116 and the inner peripheral collar portion 98a is disposed between the opposed faces of the both members 116, 98a, thereby avoiding direct action of the clinching force on the projecting part 54. The supporting force relative to the projecting part 54 by the upper and lower brackets 94, 96 is exerted in cushioned fashion via the upper and lower buffer rubbers 86, 88.

Moreover, in the present embodiment, the engagement concave portion 100 provided at the collar part 98 of the lower bracket 96 penetrates it in the up-down direction. Thus, the engagement convex portions 60, 60 of the projecting parts 54, 54 are disposed through the collar parts 98 in the up-down direction. Here, the clinch fastening part 120 of the upper bracket 94 is fastened by clinching in an area out of the engagement convex portions 60, 60 of the projecting parts 54, 54, thereby preventing the direct action of the clinching force on the projecting parts 54, 54 including the engagement convex portions 60, 60. Specifically, in this embodiment, the inner peripheral edge of the clinch fastening part 120 after the clinching process is set to be located on the radial outside of the outer peripheral edges of the projecting parts 54, 54 separately from them. Then, the clinch fastening part 120 does not touch the engagement convex portions 60, 60 of the projecting parts 54, 54 exposed to the lower side from the engagement concave portions 100, 100 of the collar part 98.

For the engine mount 10 of this embodiment, the power unit 36 is superposed on the upper side of the inner bracket 30, and the inner bracket 30 (the inner member 16) and the power unit 36 are fixed to each other by the attachment bolts 34, 34 inserted through the attachment bolt holes 32, 32. Meanwhile, the outer bracket 14 (the outer member 18) and the vehicle body 92 are fixed to each other by the mounting bolts 90, 90 protruding downward from the outer bracket 14 (the lower bracket 96). Consequently, the power unit 36 is elastically supported by the vehicle body 92, whereby the vibration input from the power unit 36 is reduced by the elastic deformation of the main rubber elastic body 20 (the linkage rubbers 72, 72).

In the engine mount 10 having the above-mentioned structure, the engagement convex portions 60, 60 protruding downward from the projecting parts 54, 54 of the outer segments 50, 50 are engaged in the engagement concave portions 100, 100 provided at the collar part 98 of the lower bracket 96. Therefore, even upon the vibration input in the diametrical direction, radial misposition between the integrally vulcanization molded component of the main rubber elastic body 20 and the outer bracket 14 can be effectively prevented. Specifically, the engagement convex portions 60, 60 are locked in the engagement concave portions 100, 100, so that the inner peripheral faces of the engagement convex portions 60, 60 are abutted on the bottom faces, which constitutes the inner faces, of the engagement concave portions 100, 100 in the front-back direction. As a result, the misposition in the radial direction (the front-back direction) between the main rubber elastic body 20 and the outer bracket 14 can be avoided. Besides, both side faces of the engagement convex portions 60, 60 touch both side faces, which constitute the inner faces, of the engagement concave portions 100, 100, in the left-right direction. This makes it possible to avoid the misposition between the main rubber elastic body 20 and the outer bracket 14 in the left-right direction as well as the circumferential direction.

Particularly, the clinching force by the clinch fastening part 120 can be directly exerted on the clinch fastening sections of the upper and lower brackets 94, 96, while the clinching force is avoided from acting directly on the projecting parts 54, 54. This can effectively prevent damages like cracks in the projecting parts 54, 54. As a result, the degree of freedom in designing the outer member 18 (the outer segments 50, 50) including the projecting parts 54, 54 improves. Therefore, it becomes possible to suitably design the shape of the outer member 18 (the outer segments 50, 50), depending on the required spring characteristics of the main rubber elastic body 20.

In this embodiment, the clamping of the projecting parts 54, 54 in the clinch fastening sections of the upper and lower brackets 94, 96 is realized via the upper and lower buffer rubbers 86, 88. Therefore, also about the dimensional error of the parts, the change of the action force during the clinching process and the like, damages of the projecting parts 54, 54 (the outer segments 50, 50) can be prevented, while stable clamping fixation force can be gotten further efficiently.

In the present embodiment, the pair of outer segments 50, 50 are adopted and bonded on the outer peripheral surface of the main rubber elastic body 20 as covering part of it. Hence, it is possible to tune the spring characteristics of the engine mount 10, based on the deformation restraint action by the outer segments 50, 50 in relation to the specific part of the main rubber elastic body 20. For example, in this embodiment, a great spring ratio can be set such that the spring characteristics in the vehicle front-back direction wherein the pair of outer segments 50, 50 are opposed is harder than the spring characteristics in the vehicle left-right direction orthogonal to the vehicle front-back direction.

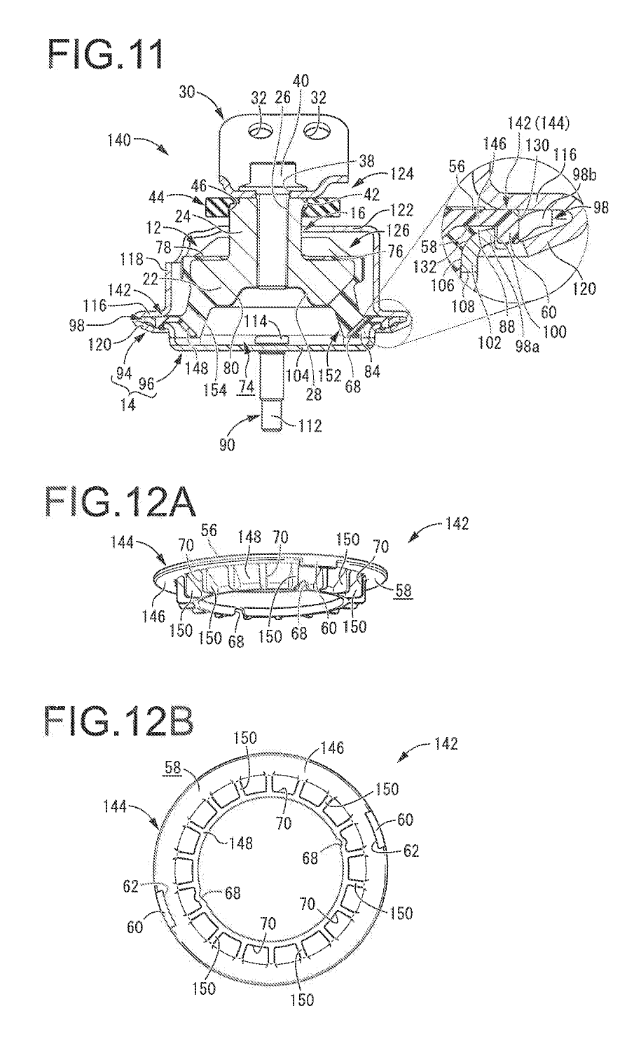

Next, FIG. 11 shows an automotive engine mount 140 serving as a second embodiment of the vibration damping device according to the present invention. In the first embodiment, the outer member 18 is constituted by including the pair of outer segments 50, 50. In this embodiment, as FIGS. 12A and 12B show, an outer member 142 is constituted by a single member. In the engine mount 140 of this embodiment, the structure except for the outer member 142 is nearly identical to that of the first embodiment. Thus, about substantially the same members and parts as those of the first embodiment, specific explanation is omitted by giving the same codes as those of the first embodiment in the drawings.

Specifically, the outer member 142 of this embodiment has a peripheral wall 144 of about annular plate shape as a whole, and the outer peripheral side of the peripheral wall 144 is a projecting part 146 of about annular plate shape. At the inner peripheral edge of the projecting part 146, a base part 148 is provided in a substantially annular plate shape or a tapered tubular shape projecting radially inward. across substantially the entire circumference in the circumferential direction. Additionally, with the outer member 142 of the present embodiment, reinforcement ribs 150 are integrally formed in a radial fashion, separately with prescribed intervals in the circumferential direction. The reinforcement ribs 150 extend in the radial directions, protruding on the lower face of the outer member 142, straddling the base part 148 and the projecting part 146. In the present embodiment, it is possible to find the whole outer member 142 has an annular block shape, wherein the projecting part 146 is provided projecting on the outer peripheral face thereof, while the lightening holes 70 are provided circumferentially between the reinforcement ribs 150, 150 adjacent to one another in the circumferential direction, so as to open downward.

In the outer peripheral edge of the projecting part 146, the engagement convex portions 60, 60 are provided protruding downward at the both side portions in the front-back direction. The engagement convex portions 60, 60 are engaged in the engagement concave portions 100, 100 provided in the collar part 98 of the lower bracket 96, as well as the first embodiment. Consequently, a main rubber elastic body 152 and the outer bracket 14 of the present embodiment are prevented from deviating in the radial direction, and they are positioned. Also in this embodiment, the step part 116 of the upper bracket 94 and the collar part 98 of the lower bracket 96 are fastened by clinching using the clinch fastening part 120. Then, in this clinch fastening section, the projecting part 146 is clamped and supported in cushioned fashion with the lower buffer rubber 88 interposed, without directly receiving the clinching force. Note that in the present embodiment, the upper buffer rubber (86) is not disposed between the lower face 130 of the step part 116 and the top face 56 of the projecting part 146.

In the first embodiment, the main rubber elastic body 20 is constituted by including the pair of linkage rubbers 72, 72 linking the inner member 16 and the outer member 18 (the outer segments 50, 50). However, in the main rubber elastic body 152 of this embodiment, a linkage rubber 154 linking the inner member 16 and the outer member 142 has a substantially annular shape or a tapered thick tube shape continuous across the whole circumference in the circumferential direction. Therefore, the spring characteristics of the main rubber elastic body 152 in the axis-perpendicular directions are made roughly uniform in the circumferential direction.

Also in the engine mount 140 of the present embodiment having the aforesaid structure, it is possible to keep the clinching force of the upper and lower brackets 94, 96 by the clinch fastening part 120, while preventing the direct action of the clinching force on the projecting part 146. Thus, the same effects as those of the first embodiment including prevention of damages in the outer member 142 and improvement of the degree of freedom in design can be exhibited.

The embodiments of the present invention have been described above, but they are just examples. The present invention should not be interpreted under any limitation by the specific descriptions about the embodiments.

For example, in the aforementioned embodiments, the linkage rubber(s) 72, 152, the stopper rubber 76, the upper rubber sheath layer 78, the lower rubber sheath layer 80, the left and right stopper rubbers 82, 82, the cover rubbers) 84, 84, the upper buffer rubber 86, and the lower buffer rubber 88 are integrally formed as the main rubber elastic body 20, 152. However, some of these rubbers may be formed independently as appropriate and each fixed to the inner member 16, the outer member 18, 142, the upper and lower brackets 94, 96, or the like. Also, in the above-described embodiments, the upper buffer rubber 86 is fixed on the top face 56 of the projecting part 54 in the outer member 18, while the lower buffer rubber 88 is fixed on the bottom face 58 of the projecting part 54, 146 in the outer member 18, 142. Alternatively, the buffer rubber(s) may be fixed on the lower face 130 of the step part 116 in the upper bracket 94 and/or the upper face 132 of the collar part 98 in the lower bracket 96. However, these upper buffer rubber 86 and lower buffer rubber 88 are not indispensable in the present invention.

In the aforesaid embodiments, the engagement convex portions 60, 60 extend out downward from the outer peripheral edges of the projecting parts 54, 146, so as to be engaged in the engagement concave portions 100, 100 provided in the lower bracket 96, but this invention is not limited to such embodiments. Specifically, the engagement convex portions 60, 60 may protrude upward from the projecting parts 54, 146, so as to be engaged in the engagement concave portions provided in the upper bracket 94. Alternatively, it is possible that the engagement convex portions are provided in the lower bracket 96 while the engagement concave portions are provided in the projecting parts 54, 146. Furthermore, it is also possible that the engagement convex portions are provided in the upper bracket 94 while the engagement concave portions are provided in the projecting parts 54, 146.

In the first embodiment, the outer member 18 is constituted by including the pair of outer segments 50, 50. However, when the outer member 18 is constituted by a plurality of outer segments 50, the number of the outer segments 50 is not limited to two. Three or more outer segments 50 may be provided, depending on the required spring characteristics of the main rubber elastic body 20 or the like. If the plurality of outer segments 50 are provided in this way, the outer segments 50 need not have the same shape. The outer segments 50 can have the shapes mutually varying depending on the required spring characteristics of the main rubber elastic body 20 or the like. Additionally, neither the protrusion directions of the engagement convex portions 60 nor the opening directions of the engagement concave portions 100 provided in the plurality of outer segments 50 need be the same direction. For example, when two outer segments 50, 50 are provided, it is possible to provide the engagement convex portion 60 protruding upward for one of the outer segments 50, while providing the engagement convex portion 60 protruding downward for the other of the outer segments 50. However, if the plurality of outer segments 50 are provided, it is not necessary to provide the engagement convex portion 60 or the engagement concave portion 100 for all of the outer segments 50. For example, they will do as long as the engagement convex portion 60 or the engagement concave portion 100 is provided in any one of the outer segments 50, considering the load input direction and magnitude.

The engagement concave portions 100, 100 are not limited to the notch-shaped concave portions provided at the collar part 98, which is the outer peripheral edge of the lower bracket 96. Alternatively, the engagement concave portion may be a through groove provided in the radially middle portion of the collar part 98, or a bottomed concavity. In addition, the engagement convex portions 60, 60 can be provided in the radially middle portions of the projecting parts 54, 146.

In the above-described embodiments, the upper bracket 94 has a generally cylindrical shape, while the lower bracket 96 has a roughly circular disk shape or a shallow-bottomed cup shape, and the clinch fastening part 120, which fastens the outer peripheral edge of the lower bracket 96 by clinching, is constituted by including the lower outer peripheral end of the upper bracket 94. However, the present invention is not limited to such embodiments. Specifically, the clinch fastening part 120 may be provided at the outer peripheral part of the lower bracket 96.

Also, the stopper mechanism constituted by the stopper part 122, the stopper rubber 76, the cushion member 44, and the like is not indispensable in the present invention.

In the aforementioned embodiments, the automotive engine mounts 10, 140 are shown as the examples of the vibration damping device according to the present invention. Meanwhile, the vibration damping device of this invention may be a differential mount, a sub frame mount, a body mount, or the like for an automobile. However, the vibration damping device according to this invention is not limited to an automotive one, and it can be applied to a vibration damping device which is not for an automobile.

### EXPLANATION OF NUMERALS

10, 140: engine mount (vibration damping device); 14: outer bracket (bracket); 16; inner member; 18, 142: outer member; 20, 152; main rubber elastic body; 50: outer segment; 52, 144: peripheral wall; 54, 146: projecting part; 60: engagement convex portion (convex portion, locking section); 84: cover rubber; 86; upper buffer rubber (buffer rubber); 88: lower buffer rubber (buffer rubber); 94: upper bracket (second assembly member, tubular member); 96: lower bracket (first assembly member, bottom side member); 98: collar part (annular fastening plate part); 100: engagement concave portion (concave portion, locking section); 116: step part (annular fastening plate part); 120: clinch fastening part

What is claimed is:

1. A vibration damping device comprising:
a main rubber elastic body;
an inner member being fixed to a central portion of the main rubber elastic body;
an outer member being fixed to an outer peripheral portion of the main rubber elastic body while having a projecting part projecting peripherally outward;
a bracket supporting the projecting part in the outer member;
a first assembly member and a second assembly member each including an annular fastening plate part so that the annular fastening plate part of the first assembly member and the annular fastening plate part of the second assembly member are superposed and fixed to each other with the projecting part between them so as to constitute the bracket;
a clinch fastening part being formed such that the annular fastening plate part of one of the first assembly member and the second assembly member is folded back to cover an outer peripheral rim of the annular fastening plate part of an other one of the first assembly member and the second assembly member, and is fastened by clinching to the annular fastening plate part of the other one with a clinching force being not directly exerted on the projecting part; and
a locking section by Which the projecting part of the outer member is locked and positioned relative to the annular fastening plate part of at least one of the first assembly member and the second assembly member.

2. The vibration damping device according to claim 1, further comprising a buffer rubber provided between the projecting part of the outer member and at least one of the first assembly member and the second assembly member clamping the projecting part.

3. The vibration damping device according to claim 1, wherein the outer member is made of synthetic resin or light metal.

4. The vibration damping device according to claim 1, wherein the outer member includes a plurality of outer segments disposed separately in a peripheral direction of the main rubber elastic body.

5. The vibration damping device according to claim 1, wherein the outer member has a peripheral wall covering an outer peripheral surface of the main rubber elastic body, while the bracket is disposed peripherally outside the peripheral wall, and a cover rubber is provided on an outer peripheral face of the peripheral wall.

6. The vibration damping device according to claim 1, wherein the locking section is constituted by a locking structure having a concave portion provided at one of the annular fastening plate part and the projecting part and a convex portion provided at an other one of the annular fastening plate part and the projecting part.

7. The vibration damping device according to claim 1, wherein
the first assembly member is constituted by a bottom side member provided at one end side of the main rubber elastic body, while the second assembly member is constituted by a tubular member disposed on an outer peripheral surface of the main rubber elastic body, and
the annular fastening plate parts superposed to each other with the projecting part of the outer member between them are provided at an outer peripheral edge of the bottom side member and an opening peripheral end on an axial side of the tubular member.
